(19) United States
(12) Patent Application Publication
(10) Pub. No.: US 2024/0258531 A1
(43) Pub. Date: Aug. 1, 2024

(54) BATTERY WITH CERAMIC BARRIER AND METHOD OF FABRICATING SAME

(71) Applicant: TECHTRONIC CORDLESS GP, Anderson, SC (US)

(72) Inventors: Aditya SUBRAMANIAN, Hong Kong (CN); Denis Gaston FAUTEUX, Hong Kong (CN); Dan GENG, Dongguan City (CN); Jin Wei LI, Dongguan City (CN)

(21) Appl. No.: 18/560,614

(22) PCT Filed: May 25, 2021
(86) PCT No.: PCT/CN2021/095662

§ 371 Date: Nov. 13, 2023

(51) Int. Cl. H01M 4/66; H01M 4/04; H01M 10/04

(52) U.S. Cl. CPC H01M 4/664; H01M 4/0404; H01M 4/661; H01M 4/667; H01M 10/0431

(57) ABSTRACT

In an example, a battery includes a metal foil. A coating is disposed on a portion of the metal foil, and an uncoated portion of the metal foil corresponds to an electrode member of the battery. The battery further includes a ceramic barrier disposed on at least a portion of a boundary between the electrode member and the coating.

### TECHNICAL FIELD

This disclosure is generally related to batteries and to fabrication processes for batteries.

### BACKGROUND

The use of various forms of batteries has become nearly ubiquitous in today's world. As more and more portable or cordless devices, such as power tools (e.g., drills, saws, grass trimmers, blowers, sanders, etc.), small appliances (e.g., mixers, blenders, coffee grinders, etc.), communications devices (e.g., smartphones, personal digital assistants, etc.), and office equipment (e.g., computers, tablets, printers, etc.), are in widespread use, the use of battery technologies of varying chemistry and configuration is commonplace.

Lithium-ion battery (LiB) configurations have gained popularity in recent years for use with respect to portable or cordless devices. LiBs may have a higher energy density than certain other rechargeable battery configurations (e.g., nickel-cadmium (NiCd) batteries), may have no memory effect, and may experience low self-discharge. As a result, LiBs provide a rechargeable battery configuration commonly utilized in today's portable or cordless devices.

The size and weight of portable or cordless devices is often an important consideration. As the size and weight of an on-board rechargeable battery system, which may include multiple individual batteries in the form of a battery pack, often contributes appreciably to the overall size and weight of the portable or cordless device, the size and weight of rechargeable batteries can be important in the design of the host devices.

Certain manufacturing processes may potentially subject batteries to wear or damage. For example, to form a LiB, various processes may be used to form electrodes (e.g., anode and cathode) and a separator of the LiB and then create a cylindrical shape of the LiB, such as by winding or rolling the electrodes and separator into a cylinder (e.g., a “jellyroll”). Ends of the electrodes (e.g., electrode members) of the LiB may be processed (e.g., crimped or otherwise placed in electrical contact) for attaching (e.g., welding) to one or more other components of the LiB or of a battery pack that includes the LiB. Such processes may potentially subject components of the LiB to damage, which may reduce product yield and increase cost of a manufacturing process.

### SUMMARY

In some aspects of the disclosure, a battery manufacturing process includes forming a foil (such as a sheet or panel of conductive material for providing a substrate for an electrode of the battery), depositing a coating (such as a cathode coating of a cathode electrode or an anode coating of an anode electrode) on a portion of the foil leaving a portion of the foil uncoated to provide an electrode member, and depositing a ceramic material (e.g., a ceramic strip or ridge) on a boundary between the uncoated foil (e.g., electrode member) and the coated foil. The ceramic material may provide one or both of mechanical protection or thermal protection to the coated foil, the uncoated foil, or both. The ceramic material may reduce or avoid wear or damage that can be caused during certain processing operations, such as a rubbing process.

To illustrate, the ceramic material may reduce thermal energy transfer from the foil to the coating. For example, a process (e.g., a rubbing process) may shape or flatten the foil of the electrode members) for placing the electrode members (e.g., uncoated ends of the electrodes) of the anode or cathode of a battery being formed in electrical contact. For example, the process may ready the electrode members for attaching to another structure (e.g., battery weld plate) by folding or rubbing together portions of the foil (e.g., spiral portions of the foil that are created using a rolling process) to create a relatively flat surface with improved electrical properties (such as reduced resistance due to connection of the spiral portions) that is to be attached (e.g., welded) to another structure.

In some cases, the process may heat the foil, which may transfer heat to the coated portion of the foil and/or the coating thereon, potentially damaging the electrode. For example, the heat generated by the process may alter or destroy materials of the coating. As another example, the heat generated by the process may damage the interface between the coating and the foil (e.g., by causing delamination, such as due to the metal of the foil and the material of the coating expanding at different rates, or by eliminating the adhesion between the coating and the foil and causing the coating and the foil to separate). Similarly, a process (e.g., laser welding process) for affixing the electrode members of the anode or cathode of a battery being formed to additional structure (e.g., battery weld plates used for connecting the battery cell to respective terminals) of the battery may transfer heat to the coated portion of the foil and/or the coating thereon, potentially damaging the electrode. A ceramic material that is disposed at the boundary of the coating and the electrode member (uncoated portion of the foil), such as may be in contact with the coating, may be configured to absorb at least some thermal energy from the foil and may prevent or mitigate transfer of at least some of the thermal energy to the interface between the foil and the coating and/or the coating itself.

Alternatively or in addition, the ceramic material may be configured to protect adhesion of the coating to the foil. For example, the interface between the foil and a coating may be subject to mechanical stress (e.g., flexing, movement, friction, etc.) during a processing to form the battery (e.g., a crimping or rubbing process to place the electrode members in electrical contact). By providing supporting structure (or “reinforcing”) the interface with a ceramic material, adhesion between the foil and the coating may be protected or damage thereto otherwise mitigated.

By reducing thermal energy transfer from the foil to the coating and/or by protecting adhesion of the coating to the foil, damage or wear associated with certain processes (such as a rubbing process, crimping process, welding process, etc.) performed in forming a battery may be reduced or avoided. As a result, product yield may be increased in some cases. Further, the ceramic material may enable certain processes (such as high speed manufacturing processes) that might otherwise cause excessive or unacceptable levels of wear or damage, thus further reducing cost associated with a battery manufacturing process.

The foregoing has outlined rather broadly some examples and technical advantages in order that the detailed description that follows may be better understood. Additional examples and advantages will also be described hereinafter. It should be appreciated by those skilled in the art that the examples disclosed may be utilized as a basis for modifying or designing other structures for carrying out the same purposes. It should also be realized by those skilled in the art that such constructions do not depart from the spirit and scope as set forth herein. The examples that follow will be better understood from the following description when considered in connection with the accompanying figures. It is to be expressly understood, however, that each of the figures is provided for the purpose of illustration and description.

### BRIEF DESCRIPTION OF THE DRAWINGS

FIG. 1A is a diagram illustrating certain aspects associated with an example of a battery fabrication process that includes forming an anode and a cathode.

FIG. 1B is a diagram illustrating certain additional aspects associated with an example of a battery fabrication process that includes forming a ceramic barrier.

FIG. 1C is a diagram illustrating certain additional aspects associated with an example of a battery fabrication process that includes performing a winding process.

FIG. 1D is a diagram illustrating certain additional aspects associated with an example of a battery fabrication process after performing the winding process of FIG. 1D.

FIG. 1E is a diagram illustrating certain additional aspects associated with an example of a battery fabrication process that includes performing a rubbing process.

FIG. 2 is a flow chart illustrating an example of a method of battery fabrication.

### DETAILED DESCRIPTION

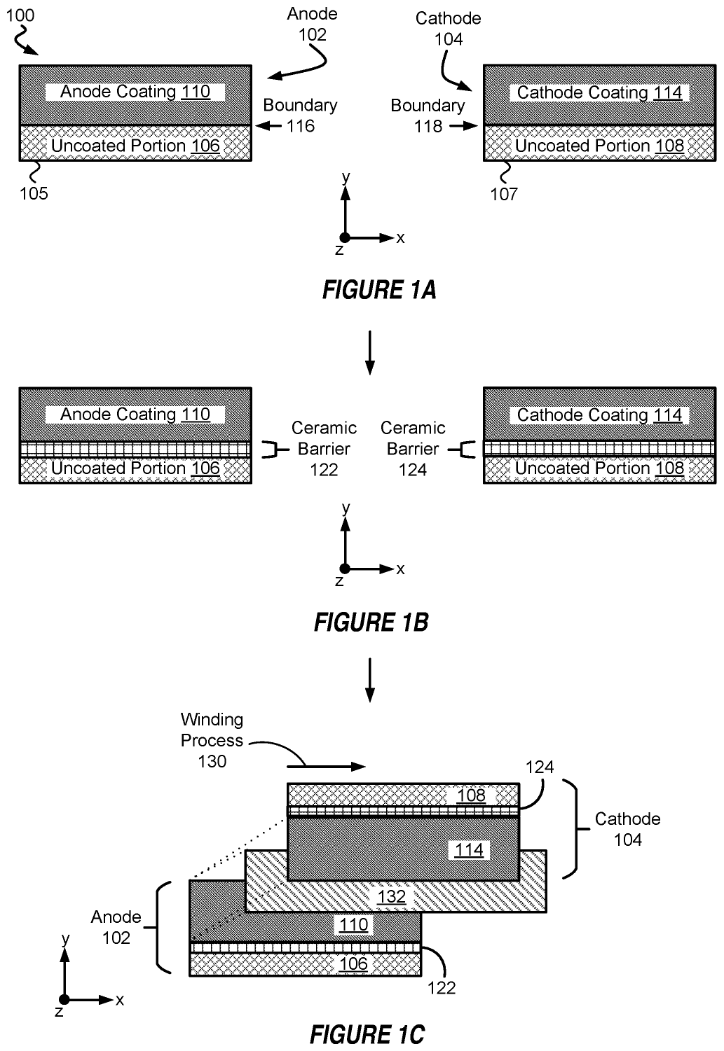

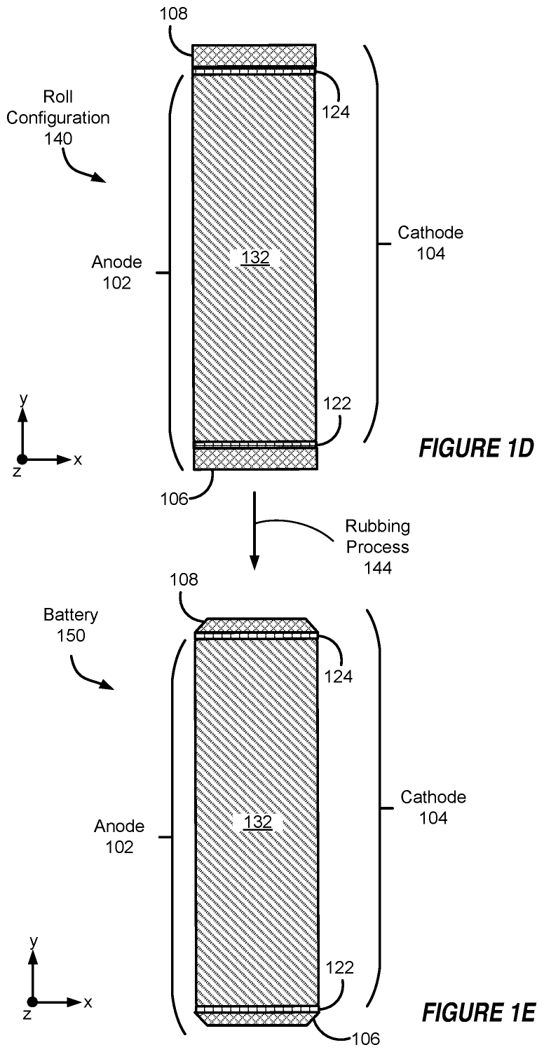

FIG. 1A is a diagram illustrating certain aspects associated with an example of a battery fabrication process 100. A battery formed through operation of battery fabrication process 100 may, for example, include anode 102 and cathode 104. The battery fabrication process 100 may include forming metal foil 105 for providing a substrate or other conductive structure for anode 102 and metal foil 107 for providing a substrate or other conductive structure for cathode 104. The metal foil 105, 107 may each include conductive material (e.g., metal) that provides a substrate for electrodes of the battery. In some examples, the metal foil 105, 107 may be referred to as “bare foil.”

The battery fabrication process 100 may further include depositing (e.g., using a coating process) an anode coating 110 on a portion of metal foil 105. The anode coating may, in some examples, comprise graphite (C₆), graphene, silicon or silicon oxide (e.g., graphene encapsulated silicon (Si) nanoparticles), etc. In accordance with embodiments of the invention, anode coating 110 may be deposited so as to leave uncoated portion 106 of metal foil 105. Uncoated portion 106 may, for example, provide a portion of foil remaining free of anode coating 110 to thereby form an anode electrode member comprising a continuous length of electrode material (e.g., the material of metal foil 105) disposed along a longitudinal edge of anode 102.

Similarly, the battery fabrication process 100 may include depositing a cathode coating 114 on a portion of metal foil 107. The cathode coating may, for example, comprise a lithium oxide alloy or compound, such as lithium cobalt oxide (LiCoO₂), lithium nickel manganese cobalt oxide (LiNiₓMn_{y}Co₂O₂ (x+y+z=1) or NMC), lithium nickel cobalt aluminum oxide (LiNiₓCo_{y}Al₂O₂ (x+y+z=1)), an olivine (e.g., such as lithium iron phosphate (LiFePO₄)), a spinel (such as lithium manganese oxide (LiMn₂O₄, Li₂MnO, or LMO)), etc. In accordance with embodiments of the invention, cathode coating 114 may be deposited so as to leave uncoated portion 108 of metal foil 107. Uncoated portion 108 may, for example, provide a portion of foil remaining free of cathode coating 114 to thereby form a cathode electrode member comprising a continuous length of an electrode material (e.g., the material of metal foil 107) disposed along a longitudinal edge of cathode 104.

The anode coating 110 is disposed on metal foil 105 and terminates at the uncoated portion 106 resulting in boundary 116. Similarly, the cathode coating 114 is disposed on metal foil 107 and terminates at the uncoated portion 108 resulting in boundary 118.

Some battery manufacturing processes include performing a rolling process to arrange the anode 102 and the cathode 104 in a roll configuration. One end (or base) of the roll configuration may include foil spirals formed by the rolled foil of the uncoated portion 106 of the metal foil 105 and the other end (or base) of the roll configuration may include foil spirals formed by the rolled foil of the uncoated portion 108 of the metal foil 107. A rubbing process may shape or flatten each end of the roll configuration (such as by folding together the rolled foil of the uncoated portion 106 of the metal foil 105 and by folding or rubbing together the rolled foil of the uncoated portion 108 of the metal foil 107). Similarly, another process (e.g., a laser welding process) that connects the rubbed foil to another structure (e.g., a battery weld plate) may transfer heat to the anode coating 110 and the cathode coating 114.

Such processes may heat the rolled foil at the ends of the roll configuration, which may transfer heat to one or both of the anode coating 110 and the cathode coating 114, potentially causing damage. For example, the heat may alter or destroy materials of one or both of the anode coating 110 and the cathode coating 114. As another example, the heat may damage an interface between the anode coating 110 and the uncoated portion 106 or an interface between the cathode coating 114 and the uncoated portion 108 of the metal foil 107 (e.g., by causing delamination or separation of the anode coating 110 and the uncoated portion 106 of the metal foil 105, by causing delamination or separation of the cathode coating 114 and the uncoated portion 108 of the metal foil 107, or both).

A ceramic material that is disposed at the boundaries 116, 118 may be configured to absorb at least some of the heat, to provide mechanical protection between the anode coating 110 and the uncoated portion 106 of the metal foil 105 and between the cathode coating 114 and the uncoated portion 108 of the metal foil 107, or a combination thereof. As a result, damage (such as the altering or destruction of materials of the coatings, or the delamination or separation of coating from uncoated foil) may be reduced or avoided, which may increase product yield in some cases. Further, the ceramic material may enable certain processes (such as high speed manufacturing processes) that might otherwise cause excessive or unacceptable levels of wear or damage, thus further reducing cost associated with a battery manufacturing process.

FIG. 1B is a diagram illustrating certain additional aspects associated with an example of the battery fabrication process 100. In FIG. 1B, the battery fabrication process 100 includes forming a ceramic barrier 122 (e.g., a ceramic strip or ridge) on at least a portion of the boundary 116 and forming a ceramic barrier 124 (e.g., a ceramic strip or ridge) on at least a portion the boundary 118. The ceramic barrier 122 may adjoin, cover, or conceal at least a portion of the boundary 116, and the ceramic barrier 124 may adjoin, cover, or conceal at least a portion of the boundary 118. The ceramic barrier 122 may be in contact with a portion of the uncoated portion 106 and with a portion of the anode coating 110, and the ceramic barrier 124 may be in contact with a portion of the uncoated portion 108 and a portion of the cathode coating 114. In some examples, the x-y plane of the metal foil 105 forms a substrate, and ceramic material is deposited on the substrate (e.g., in the z direction) to form the ceramic barrier 122. In some examples, the x-y plane of the metal foil 107 forms a substrate, and ceramic material is deposited on the substrate (e.g., in the z direction) to form the ceramic barrier 124.

In some examples, the ceramic barriers 122, 124 include an aluminum oxide material or a zirconium oxide material, as illustrative examples. Alternatively or in addition, the ceramic barriers 122, 124 may include one or more other materials. The ceramic barriers 122, 124 may include material with a relatively low thermal conduction property. To illustrate, the ceramic barriers 122, 124 may include or correspond to a material having a thermal conductivity that is less than thermal conductivities of materials of the uncoated portion 106, the anode coating 110, the uncoated portion 108, and the cathode coating 114.

In some examples, the ceramic barriers 122, 124 are formed using a slot-die coating process. For example, performing the slot-die coating process may include operating a slot-die coating system that includes a reservoir of ceramic material, a pump, and a slot-die. The pump may provide ceramic material from the reservoir to the slot-die, and the slot-die coating system may move the slot-die across the boundaries 116, 118 while applying the ceramic material to the boundaries 116, 118. In other implementations, a different process may be used to form the ceramic barriers 122, 124.

FIG. 1C shows an example of a winding process 130. For example, the anode 102, the cathode 104, and the separator 132 may be rolled or wound via the winding process 130 to create a roll configuration (such as a cylindrical “jellyroll” configuration), and the uncoated portions 106, 108 may extend out as electrode members at the ends of the roll configuration. To further illustrate, the anode 102, the cathode 104, and the separator 132 may be supplied to a winding station and may be wound together into the roll configuration. In some examples, a pin or tube may be provided so that the anode 102, the cathode 104, and the separator 132 may be wound around the pin or tube during the winding process 130. The pin or tube may be removed after completing the winding process 130. In some examples, the separator 132 includes one or more polyolefin materials, such as one or both of polypropylene or polyethylene. The separator 132 may be coated with a ceramic layer on one or more sides, which may increase a mechanical strength associated with the separator 132.

In some implementations, a subtractive process (such as patterning, drilling, cutting, or etching) may be used to form one or more slits in the ceramic barriers 122, 124 prior to performing the winding process 130. As an example, a laser drilling process may be performed to form one or more slits in the ceramic barriers 122, 124. In some cases, the slits may relieve tension or stress on the ceramic barriers 122, 124 that may be caused by the winding process 130. As a result, the silts may assist in the winding process 130 in some implementations.

FIG. 1D shows an example of a roll configuration 140 (e.g., a cylindrical jellyroll configuration) of the anode 102, the cathode 104, and the separator 132 after performing the winding process 130 of FIG. 1C. In FIG. 1D, the anode 102, the cathode 104, and the separator 132 are disposed in the roll configuration 140 that is at least partially enclosed within the separator 132, and the uncoated portions 106, 108 extend out as ends of the roll configuration 140. In some implementations, a length (in the x direction) of the separator is greater than lengths of the anode 102 and the cathode 104, which may enable the separator 132 to cover the rolled anode 102 and cathode 104 in the roll configuration 140. In this case, the separator 132 may form at least a portion of an exterior layer of the roll configuration 140 (in addition to providing separation to the anode 102 and the cathode 104).

FIG. 1E shows an example of a battery 150 after performing a rubbing process 144 on the roll configuration 140. The rubbing process 144 may include flattening, smoothening, bending, or planarizing the uncoated portions 106, 108 to smooth, shape, or resize the electrode members provided by uncoated portions 106, 108. To further illustrate, the rubbing process 144 may shape the uncoated portions 106, 108 to form the uncoated portions 106, 108 as electrical contacts that can be attached to one or more other structures. For example, the rubbing process 144 may include crimping together portions of the uncoated portions 106, 108 (e.g., spiral portions of the uncoated portions 106, 108 that are created using the winding process 130) to create a relatively flat surface with improved electrical properties (such as reduced resistance resulting from connection of the spiral portions) that is to be attached (e.g., welded) to another structure. As will be appreciated, operations to position the uncoated portions 106, 108 (such as rubbing, folding, or crimping, etc.) during the rubbing process 144 may transfer heat and mechanical stress from the uncoated portions 106, 108 to the coatings 110, 114, to the uncoated portions 106, 108 from the coatings 110, 114, or a combination thereof.

The battery 150 may include an electrolyte, which may be disposed between the anode 102 and the cathode 104 within the roll configuration 140. The electrolyte may include one or more organic solvents, a polymer electrolyte, a ceramic solid electrolyte, an ionic liquid electrolyte, one or more other materials, or a combination thereof. As an example, an electrolyte may include a lithium salt in an organic solvent, such as an organic carbonate (e.g., ethylene carbonate or diethyl carbonate) containing complexes of lithium ions (e.g., an anion salt, such as lithium hexafluorophosphate (LiPF₆), lithium hexafluoroarsenate monohydrate (LiAsF₆), lithium perchlorate (LiClO₄), lithium tetrafluoroborate (LiBF₄), lithium triflate (LiCF₃SO₃), etc.).

Forming the battery 150 may further include one or more other operations, such as one or more operations of an assembly process. To illustrate, the assembly process may include attaching a weld plate to the anode 102 and attaching a weld plate to the cathode 104 (e.g., using a welding process). The weld plates may provide electrically conductive surfaces associated with the battery 150. In some implementations, the assembly process may include attaching a cap of the battery 150 to one weld plate (e.g., using a cap scaling process or a cap welding process) and may include attaching a base of the battery 150 to the other weld plate (e.g., using a welding process, such as a bottom welding process). To further illustrate, in some examples, a weld plate may include a tab (e.g., a protrusion of the weld plate) that may be welded to the cap. Depending on the particular implementation, the assembly process may further include one or more other operations, such as attaching a can of the battery 150 (e.g., to a weld plate via a can insertion operation), attaching a header of the battery 150 (e.g., to the other weld plate), attaching a housing (e.g., by inserting the roll configuration within the housing after attaching the weld plates to the roll configuration), performing a crimping operation, performing electrolyte injection, performing a scaling operation, performing one or more other operations, or a combination thereof.

In some implementations, the ceramic barrier 122 is configured to reduce thermal energy transfer to the anode coating 110 from the uncoated portion 106, and the ceramic barrier 124 is configured to reduce thermal energy transfer to the cathode coating 114 from the uncoated portion 108. For example, a rubbing process may heat a foil portion, which may transfer the heat to the coating during a rubbing process, potentially damaging the coating or an interface between the foil and the coating. A ceramic coating that is in contact with portions of the anode coating 110 may absorb at least some thermal energy from the coating and may prevent transfer of at least some the thermal energy to the foil portion. For example, because the ceramic barrier 122 is disposed on the uncoated portion 106, the ceramic barrier 122 may prevent, reduce, or absorb transfer of thermal energy and/or mechanical energy created during certain processes (such as the rubbing process 144) from the uncoated portion 106 to the anode coating 110. As another example, because the ceramic barrier 124 is disposed on the uncoated portion 108, the ceramic barrier 124 may prevent, reduce, or absorb transfer of thermal energy and/or mechanical energy created during certain processes (such as the rubbing process 144) from the uncoated portion 108 to the cathode coating 114.

Alternatively or in addition, the ceramic barrier 122 may be configured to protect adhesion of the anode coating 110 to the uncoated portion 106, and the ceramic barrier 124 may be configured to protect adhesion of the cathode coating 114 to the uncoated portion 108. For example, the interface between a foil portion and a coating material may be subject to mechanical stress (e.g., friction) during a rubbing process. By supporting (or “reinforcing”) the interface with a ceramic barrier, adhesion between the foil portion and the coating may be increased, which may avoid damage or wear associated with mechanical stress in some cases.

In some implementations, one or more dimensions of the ceramic barriers 122, 124 may be selected based on one or more criteria. To illustrate, in some examples of the battery fabrication process 100, a width of the ceramic barriers 122, 124 (e.g., in the y direction) may be selected to be greater than or equal to a height of the ceramic barriers 122, 124 (e.g., in the z direction), which may increase stability of the ceramic barriers 122, 124 (e.g., by reducing or preventing the ceramic barriers 122, 124 from “falling”). As a non-limiting illustrative example, the width of the ceramic barriers 122, 124 may be between 0.1 millimeters (mm) and 3.0 mm. In some other implementations, the ceramic barriers 122, 124 may have a different width. In some implementations, a height of the ceramic barriers 122, 124 (e.g., in the z direction) may be less than or equal to a height of the coatings 110, 114. Further although the example of FIG. 1B illustrates that the length of the ceramic barriers 122, 124 (e.g., in the x direction) may be approximately the same as lengths of the boundaries 116, 118, in some other examples, lengths of the ceramic barriers 122, 124 may be less than lengths of the boundaries 116, 118.

Alternatively or in addition, one or more dimensions of the ceramic barriers 122, 124 may be selected based on one or more properties of a ceramic material that is included in the ceramic barriers 122, 124. To illustrate, the one or more properties may include a thermal conductivity of the ceramic material. In some examples, by increasing a width of the ceramic barriers 122, 124 (e.g., in the y direction), a thermal absorption capability of the ceramic barriers 122, 124 may be increased (e.g., by increasing an amount of thermal energy capable of being absorbed by the ceramic barriers 122, 124, by increasing a rate at which the ceramic barriers 122, 124 absorb thermal energy, or both). In other implementations, the width of the ceramic barriers 122, 124 may be decreased, such as in connection with certain applications associated with a low amount of thermal energy or a low rate of thermal energy transfer from the uncoated portions 106, 108 to the coatings 110, 114.

One or more techniques described with reference to FIGS. 1A-1E may reduce cost or increase effectiveness of a battery manufacturing process. For example, by reducing thermal energy transfer from the foil portion to the coating and by increasing adhesion of the coating to the foil portion, damage or wear associated with certain processes (such as a rubbing process that shapes or flattens a foil portion, or one or more “downstream” processes that follow the rubbing process) may be reduced or avoided. As a result, product yield may be increased in some cases. Further, the ceramic material may enable certain processes (such as high speed manufacturing processes) that might otherwise cause wear or damage, thus further reducing cost associated with a battery manufacturing process.

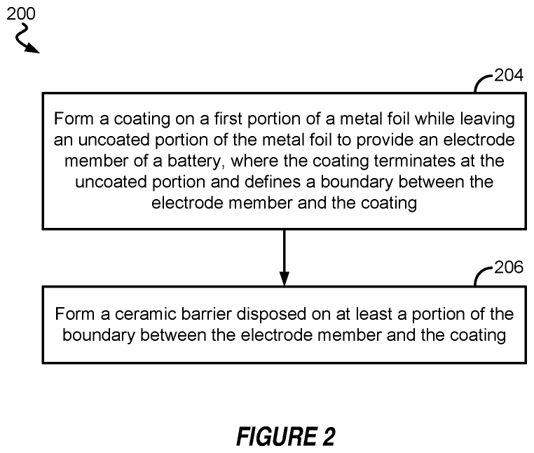

FIG. 2 is a flow chart illustrating an example of a method 200 of battery fabrication. In some examples, the method 200 is performed to fabricate the battery 150. Operations of the method 200 may be initiated, performed, or controlled by fabrication equipment, which may include a processor and a memory. The processor may retrieve instructions from the memory and may execute the instructions to initiate, perform, or control one or more operations of the method 200. For example, the processor may execute the instructions to control operation of the slot-die coating system described with reference to FIG. 1B.

The method 200 includes forming a coating on a first portion of a metal foil while leaving an uncoated portion of the metal foil to provide an electrode member of a battery, at 204. For example, the metal foil may correspond to the metal foil 105, and the coating may correspond to the anode coating 110. In another example, the metal foil may correspond to the metal foil 107, and the coating may correspond to the cathode coating 114. The coating terminates at the uncoated portion and defines a boundary between the electrode member and the coating. For example, the anode coating 110 may be formed on the metal foil 105, leaving the uncoated portion 106, which may correspond to the electrode member of the battery. The anode coating 110 and the uncoated portion 106 may form the boundary 116. As another example, the cathode coating 114 may be formed on the metal foil 107, leaving the uncoated portion 108, which may correspond to the electrode member of the battery. The cathode coating 114 and the uncoated portion 108 may form the boundary 116.

The method 200 further includes forming a ceramic barrier disposed on at least a portion of the boundary between the electrode member and the coating, at 206. For example, the ceramic barrier 122 may be formed on at least a portion of the boundary 116. As another example, the ceramic barrier 124 may be formed on at least a portion of the boundary 118.

A battery described herein may be integrated into an electronic device. In some implementations, multiple batteries may be integrated into a battery pack of an electronic device. Examples of electronic devices include various portable or cordless devices, such as power tools (e.g., drills, saws, grass trimmers, blowers, sanders, etc.), small appliances (e.g., mixers, blenders, coffee grinders, etc.), communications devices (e.g., smartphones, personal digital assistants, etc.), and office equipment (e.g., computers, tablets, printers, etc.). Further, although examples of batteries and battery packs have been described with reference to use in various portable or cordless devices, it should be appreciated that use of such batteries and battery packs is not so limited. Batteries and battery packs configured to provide high power and high energy density in accordance with examples herein may, for example, be utilized in powering such devices as electric vehicles, backup/uninterruptable power supplies, etc.

Although certain examples have been described, it should be understood that various changes, substitutions and alterations can be made herein without departing from the spirit and scope of the disclosure. Moreover, the scope of the disclosure is not intended to be limited to the particular examples of the process, machine, manufacture, composition of matter, means, methods, and steps described in the specification. As one of skill in the art will readily appreciate from the disclosure, processes, machines, manufacture, compositions of matter, means, methods, or steps, presently existing or later to be developed that perform substantially the same function or achieve substantially the same result as the corresponding examples described herein may be utilized. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A battery comprising:
a metal foil, wherein a coating is disposed on a portion of the metal foil, and wherein an uncoated portion of the metal foil corresponds to an electrode member of the battery; and
a ceramic barrier disposed on at least a portion of a boundary between the electrode member and the coating.

2. The battery of claim 1, wherein the ceramic barrier is configured to reduce one or more of thermal energy transfer or mechanical stress to the coating from the electrode member, to the electrode member from the coating, or both.

3. The battery of claim 1, wherein the ceramic barrier is configured to protect adhesion of the coating to the electrode member.

4. The battery of claim 1, wherein the ceramic barrier includes an aluminum oxide material.

5. The battery of claim 1, wherein the ceramic barrier includes a zirconium oxide material.

6. A method of fabrication of a battery, the method comprising:
forming a coating on a first portion of a metal foil while leaving an uncoated portion of the metal foil to provide an electrode member of the battery, wherein the coating terminates at the uncoated portion and defines a boundary between the electrode member and the coating; and
forming a ceramic barrier disposed on at least a portion of the boundary of the electrode member and the coating.

7. The method of claim 6, further comprising selecting one or more dimensions of the ceramic barrier based on one or more properties of a ceramic material included in the ceramic barrier.

8. The method of claim 7, wherein the one or more properties include a thermal conduction of the ceramic material.

9. The method of claim 6, wherein the ceramic barrier includes an aluminum oxide material.

10. The method of claim 6, wherein the ceramic barrier includes a zirconium oxide material.

11. The method of claim 6, wherein the ceramic barrier is configured to reduce one or more of thermal energy transfer or mechanical stress to the coating from the electrode member, to the electrode member from the coating, or both.

12. The method of claim 6, wherein the ceramic barrier is configured to protect adhesion of the coating to the electrode member.

13. A battery comprising:
a metal foil, wherein a coating is disposed on a portion of the metal foil, and wherein an uncoated portion of the metal foil corresponds to an electrode member of the battery;
a ceramic barrier disposed on at least a portion of a boundary between the electrode member and the coating;
an anode;
a cathode; and
a separator, wherein the anode, the cathode, and the separator are disposed in a roll configuration.

14. The battery of claim 13, wherein the ceramic barrier is configured to reduce one or more of thermal energy transfer or mechanical stress to the coating from the electrode member.

15. The battery of claim 13, wherein the ceramic barrier is configured to protect adhesion of the coating to the electrode member.

16. The battery of claim 13, wherein the ceramic barrier includes an aluminum oxide material.

17. The battery of claim 13, wherein the ceramic barrier includes a zirconium oxide material.

18. The battery of claim 13, wherein one or more dimensions of the ceramic barrier are based on one or more properties of a ceramic material included in the ceramic barrier.

19. The battery of claim 18, wherein the one or more properties include a thermal conduction of the ceramic material.

20. The battery of claim 18, wherein the one or more properties include a dimension of the coating.
